(19) United States
(12) Patent Application Publication
(10) Pub. No.: US 2004/0226445 A1
(43) Pub. Date: Nov. 18, 2004

(54) Air purifier

(75) Inventors: Ching-Jong Su, San Jose, CA (US); Ren-Kang Chiou, Fremont, CA (US); Edward Wei-Jo Lee, Mountain View, CA (US)

Correspondence Address: TROXELL LAW OFFICE PLLC, Suite 1404, 5205 Leesburg Pike, Falls Church, VA, 22041, US

(73) Assignee: MA LABORATORIES, INC.

(21) Appl. No.: 10/436,279

(22) Filed: May 13, 2003

(51) Int. Cl. B03C 3/00

(52) U.S. Cl. 96/15

(57) ABSTRACT

An air purifier is constructed to include a conduit housing a high voltage circuit board and a high voltage generator in a rear section thereof and at least one high voltage electrode and a number of ground electrodes in a front section thereof, the high voltage electrode and ground electrodes functioning as an ionizer as well as an electrostatic precipitator, trapping and removing contaminants from the air when receiving a high voltage output from the high voltage generator, so that air flowing by the high voltage electrode gets ionized and, floating contaminant particles are then combined with air ions, which are drawn to the ground electrodes and get trapped and neutralized by the ground electrodes.

### BACKGROUND OF THE INVENTION

1. Field of the Invention

The present invention relates generally to devices used for removing contaminants from the air within any electronic equipment, more specifically, a personal computer system.

2. Description of the Related Art

Inside the enclosed case of a personal computer system, temperature warms up because of the heat generated by its components. The design of thermal management becomes very important in order to prevent the computer from overheating which degrades not only system performance but also system reliability. Fans and heat-sinkers are popular means used to remove heat from components such as CPU, AGP, Power Supply, etc. and dump it into the ambient inside the case. Additionally, fans are widely used to keep the case ambient temperature low by taking cool room air in and blowing hot air out of the case. During this process, it is inevitable that contaminants are carried with the air circulation. Hence the quality of air near the computer is poor. For an office area where tens or hundreds of personal computers are running simultaneously, the air quality is even worse. As for the computer, some contaminants get trapped and accumulating inside the case, settling on the surface of all components and causing them to have degraded thermal conductivity. We invented a new method of removing contaminants from the inside of a personal computer and improving the quality of room or office air at the same time. To achieve this goal, an electronic equipment air purifier is designed based on the principles of air ionization and electrostatic precipitation. Either positive or negative ionization can be utilized to accomplish the task. Negative ionization is preferred because of the various well-known health benefits of negative ions to human beings.

### SUMMARY OF THE INVENTION

The present invention has been accomplished under the circumstances in view. The main objective of this air purifier is to provide a new and better method of removing contaminants from the air within the computer system. Another objective of the present invention is to minimize the contaminants in the air exhausted from the computer system thus improving the air quality for the room or office area where the computer systems are located. An additional objective of the present invention is to provide an air purifier for the computer system that is simple and easy to use. A still further objective of the present invention is to provide an air purifier that also releases negative ions for their benefits to human health.

This air purifier includes a conduit in which the flow of air, either naturally or with the assist of fans, is conveyed so as to pass in succession a first electrode with high voltage and an electrically grounded second electrode. The air purifier can be installed into the personal computer system from three directions: the front, the side, and the back. Virtually all contaminant particles in the air have a positive charge. Normally negative high voltage is applied to the first electrode to generate negative ions. They flow naturally towards the ground (a relatively positive voltage) electrode while attracting positively charged contaminants with them. Together they reach the ground electrode and get neutralized. The contaminants are left on the ground electrode and can be wiped clean by hand periodically when the ground electrode is pulled out of the air purifier. This way, the contaminants inside the computer system get cleaned. Negative ions are also released into the room or office from a front opening of the air purifier or from the backside of computer with the exhaust air. They attract floating contaminants in the air and become heavy enough to fall. When there is a high concentration of negative ions, lots of floating contaminants are removed from the air and not inhaled by human. The fallen contaminants are collected by the usual cleaning activities such as dusting, wiping, vacuuming or mopping. If the contaminants were disturbed and floated back into the air, they will be collected again by the negative ions and once more settled out of the air. Hence air quality of the room or office area is further improved. Beyond improving air quality, negative ions provide many benefits to human health, which have been well researched and documented. Here are some of the documented benefits: effective against allergies and asthma by removing solid pollutants such as pollen, down, smoke, dust and chemical fibers; decreases the airborne bacteria count by halting the growth of bacteria, fungi and staphylococci; balances serotonin in the body to help alertness, concentration, and to relieve tension, depression, irritability and sleeplessness; improves body's pH and hormonal balance, and detoxifies the body; strengthens the human immune system and reduces susceptibility to cold and flu; boosts the absorption of nutrients, especially for vitamins C and B complex; increases lung capacity by cleaning cilia, the microscopic hairs in the windpipe which filters air that enters the lungs. If positive high voltage were used and thus generating positive ions, air within the computer system still get purified under similar principles as were described earlier for the case of negative ions. And some excess positive air ions are also released into the room or office, but they have no extra benefit to air quality or to human health. An option of the present invention is a device built just for generating negative ions, with no contaminants collecting electrode, and releasing them from its front for the cleansing of indoor air as well as benefiting human health. Special negative ion generating pads are another added option of the present invention. Typically four pads are available and can be applied to part of human body under stress or suffering, for example hands or knees that are suffering from arthritis. It is said that negative ions have some healing effect on body wounds because they neutralize all the positive ions that are generated by the wounds. Optionally, a much larger unit can be built for use as a conventional room air purifier with negative ions generation capability to benefit human health at the same time.

### BRIEF DESCRIPTION OF THE DRAWINGS

FIG. 1 depicts the case enclosure of a personal computer system with an air purifier according to the present invention.

FIG. 2 displays the internal arrangement of the air purifier according to the present invention.

FIG. 3 is a circuit block diagram of the high voltage generator according to the present invention.

FIG. 4 shows an alternate form of the air purifier according to the present invention.

### DETAILED DESCRIPTION OF THE PREFERRED EMBODIMENT

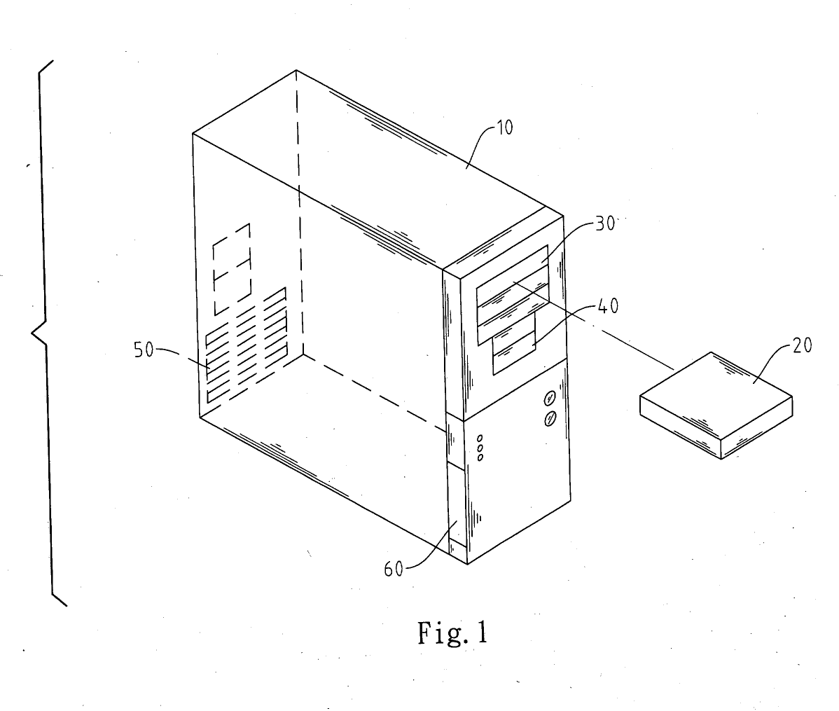

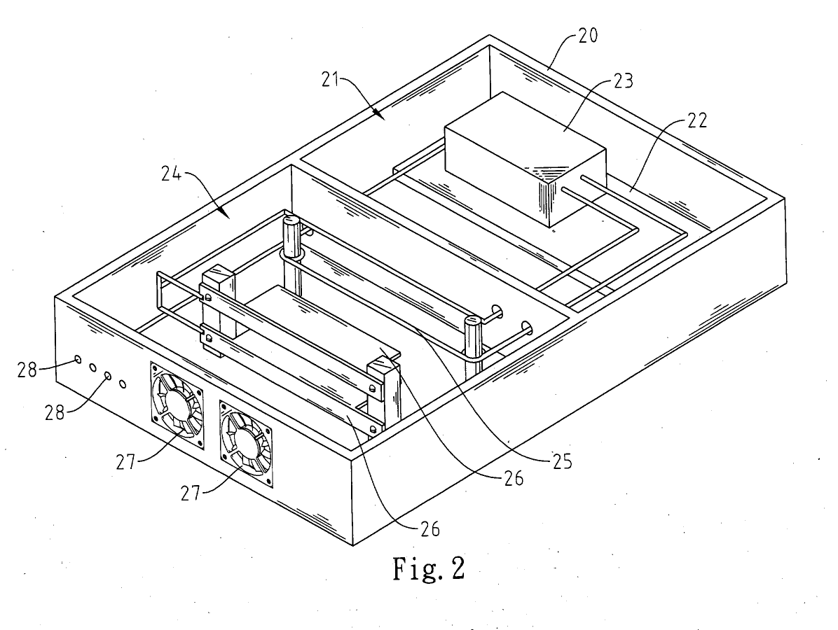

Referring to FIGS. 1 and 2, an air purifier in accordance with the present invention comprises a conduit 20, which can be applied to an enclosure case 10 for personal computer system from three directions: the front, the side, and the back. For example, the conduit 20 can be installed from the front into a standard 5¼″ wide opening dock 30 or a standard 3½″ wide opening dock 40, or installed from the back into a standard opening slot 50 normally used for connecting an internal add-on circuit card. Or it can be installed from the side into a custom opening 60 in the front or on the side of the computer enclosure case 10.

The conduit 20 has a back section 21 housing a high voltage circuit board 22 and a high voltage generator 23. It also includes a front section 24 for accommodating at least one high negative (or positive) voltage electrode 25, a plurality of ground electrodes 26, and electric fans 27. The high voltage generator 23 has a high voltage output terminal electrically connected to the high voltage electrode 25, and a ground terminal electrically connected to the ground electrodes 26.

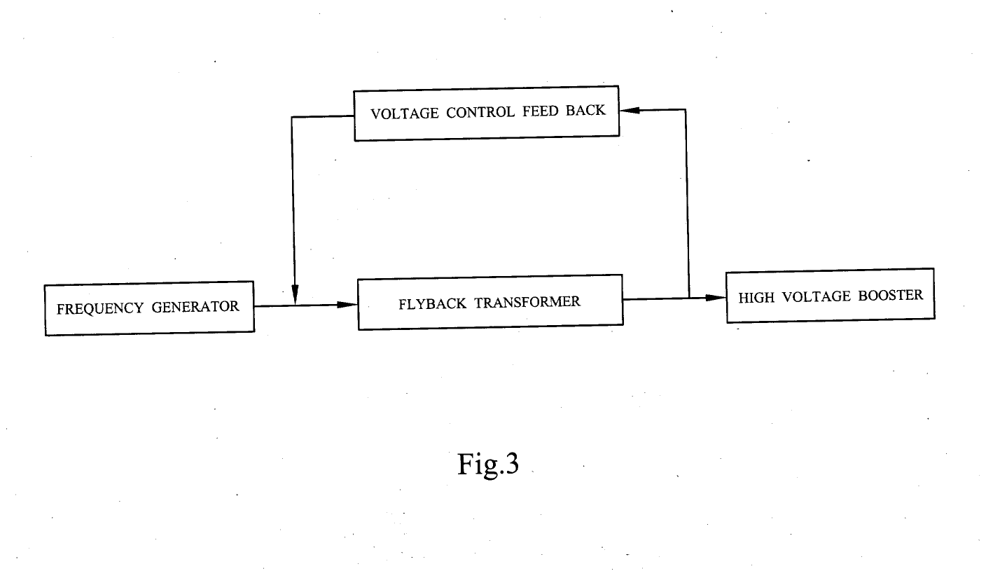

Referring to FIG. 3, the high voltage circuit board 22 is adapted to receive DC (typical 12V) or AC (typical 115V or 230V) power input, having a rectifier (not shown) that converts AC power input into 12V DC output. The high voltage generator 23 is comprised of a frequency generator, a flyback transformer, a voltage controlled feedback, and a high voltage multiplier. The high voltage circuit board 22 and generator 23 in the back section 21 supplies a high voltage (AC or DC) to electrode 25. Applying the voltage output of generator 23 to electrodes 25, 26 enabling them to function as an ionizer as well as an electrostatic precipitator, trapping and removing contaminants from the air inside the computer system.

When air flows by the high voltage electrode 25, it gets ionized. Floating contaminant particles are then combined with air ions, which are drawn to the ground electrode 26. They get trapped and neutralized by the grounded electrode 26. In this way, contaminants are left deposited on electrode 26 and removed from the air. Thus the air quality gets improved. When the removable electrode 26 is pulled out, contaminants can be easily wiped off with a tissue paper or a damp towel. After drying, electrode 26 can be reinstalled and ready to function again. Since negative high voltage is used, excess negative ions are released mainly from the front opening of the conduit 20 but some also from the back of computer together with the exhaust air. Floating contaminants are attracted to negative air ions and become heavy enough to fall down and thus avoided being inhaled by human. Therefore the air quality of the room or office where the computer system is located gets further improved. The electrical fans 27 increase airflow, enhancing the air purification and the release of negative ions. An added special feature with negative-ion-generating pads is another option of the present invention. A typical design with four connection (ports) positions 28 is shown.

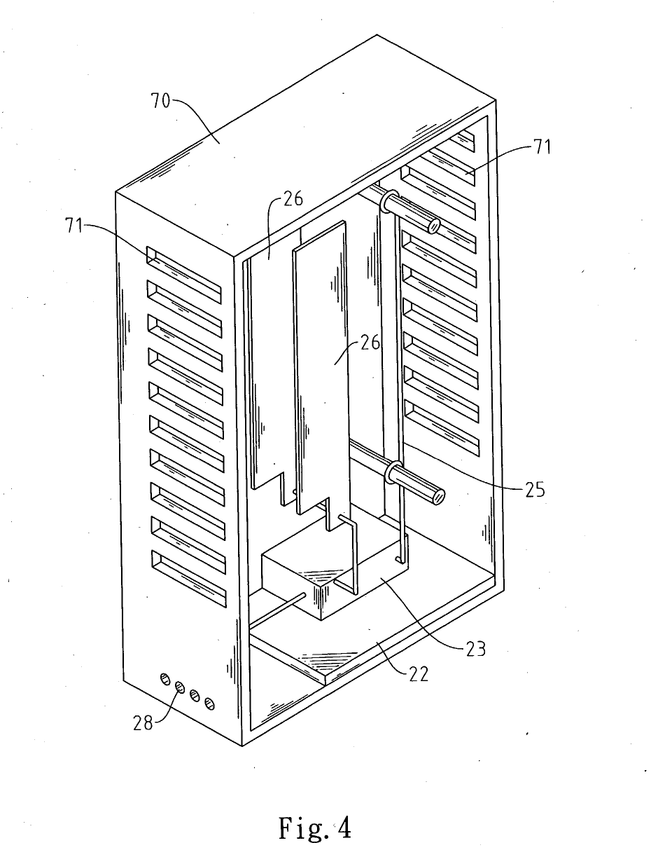

FIG. 4 displays a room air purifier 70 based on the same principle of using negative ions to purify room air and benefit human health. The front side has built-in grille 71 for air outlet. Similarly the backside has built-in grille for air inlet. There is one or more high negative voltage electrode 25 and two or more ground electrode 26. The high voltage circuit board 22 and generator 23 inside (shown at the bottom) supplies the high voltage (AC or DC) to electrode 25. Air flowing by the high voltage electrode 25 gets ionized. Floating contaminant particles are then combined with air ions and subsequently attracted to the ground electrode 26. They get trapped and neutralized by the ground electrode 26. In this way, the contaminants are left deposited on electrode 26 and removed from the air. Thus the air quality becomes improved. With the removable ground electrode 26 pulled out, contaminants can be easily wiped off with a tissue paper or a damp towel. After drying, electrode 26 can be reinstalled and ready to function again. Excess negative ions are also released from the front opening of the air purifier 70. Once outside, they attract more floating contaminants and make them heavy enough to fall down and thus avoided being inhaled by human. Hence the air quality of the room gets further improved. The design of this room air purifier can be of any shape or size and powered by either AC (typical 115 or 230V) or DC (typical 12V) sources. It can be miniaturized to fit special applications such as in closets, cars, . . . etc. In here it is presented as a rectangular parallelepiped (box) shape with the advantage of being easily stacked upward or cascaded laterally to meet extra capacity demanded by large office or meeting hall. A little mechanical design novelty can easily accomplish this stacking and expansion securely. One characteristic of this air purifier is especially worth mentioning. Because the air flows naturally in the direction from the high voltage electrode 25 to the ground electrode 26, fans are not required. Therefore its operation is extremely quiet.

Although particular embodiments of the invention have been described in detail for purposes of illustration, various modifications and enhancements may be made without departing from the spirit and scope of the invention. Accordingly, the invention is not to be limited to the particular embodiments shown and described, but is to be accorded the widest scope consistent with the principles and novel features herein disclosed.

What the invention claimed is:

1. An air purifier comprising a conduit appliable to the enclosure case of a personal computer system for conveying air, wherein said conduit has a back section housing a high voltage circuit board and a high voltage generator, and a front section accommodating at least one high voltage electrode and a plurality of ground electrodes, said high voltage generator having a high voltage output terminal electrically connected to said at least one high voltage electrode and a ground terminal electrically connected to said ground electrodes, said at least one high voltage electrode and said ground electrodes functioning as an ionizer as well as an electrostatic precipitator, trapping and removing contaminants from the air inside the computer system in which the air purifier is installed when receiving a high voltage output from said high voltage generator, so that air flowing by said at least one high voltage electrode gets ionized and, floating contaminant particles are then combined with air ions, which are drawn to said ground electrodes and get trapped and neutralized by said ground electrodes.

2. The air purifier of claim 1 wherein said conduit is appliable to the enclosure case of a personal computer system from three directions: the front, the side, and the back.

3. The air purifier of claim 1 wherein said conduit is appliable to a standard 5¼″: wide opening dock or a standard 3½″ wide opening dock of the enclosure case of a personal computer system.

4. The air purifier of claim 1 wherein said conduit is appliable to a standard opening slot in the back side of the enclosure case of a personal computer system normally used for connecting an internal add-on circuit card.

5. The air purifier of claim 1 wherein said conduit is appliable to a custom opening in the front or on the side of the enclosure case of a personal computer system.

6. The air purifier of claim 1 wherein said high voltage circuit board is adapted to receive DC (typical 12V) or AC (typical 115V or 230V) power input.

7. The air purifier of claim 1 wherein said ground electrodes are disconnectable from said conduit for cleaning manually.

8. The air purifier as claimed in claim 1 further comprising at least one electric fan selectively installed in one the front and/or the back of said conduit.

9. The air purifier of claim 1 wherein said conduit has a plurality of high negative voltage output ports for the connection of negative-ion-generating pads that can be applied to part of human body under stress or suffering.

10. An air purifier comprising a conduit for conveying air, said conduit having at least one built-in grille for air outlet and at least one built-in grille for air inlet, at least one high voltage electrode and a plurality of ground electrodes mounted inside said conduit, a high voltage circuit board and generator mounted inside said conduit and supplying a high voltage to said at least one high voltage electrode, so that air flowing by said at least one high voltage electrode gets ionized and, floating contaminant particles are then combined with air ions and subsequently attracted to said ground electrodes and get trapped and neutralized by said ground electrodes.

11. The air purifier of claim 10 wherein said air conduit is shaped like a rectangular case having six sides with the advantage of being easily stacked upward or cascaded laterally to meet demand of extra capacity. It can also be miniaturized for special applications in closets, cars, . . . etc.

12. The air purifier of claim 10 wherein said ground electrodes are disconnectable from said conduit for cleaning manually.

13. The air purifier of claim 10 wherein said high voltage circuit board is adapted to receive DC (typical 12V) or AC (typical 115V or 230V) power input.

14. The air purifier as claimed in claim 10 further comprising at least one electric fan selectively installed in the front and/or back of said conduit.

15. The air purifier of claim 10 wherein said conduit has a plurality of high negative voltage output ports for the connection of negative-ion-generating pads that can be applied to part of human body under stress or suffering.
